(19) United States
(12) Patent Application Publication
(10) Pub. No.: US 2012/0042264 A1
(43) Pub. Date: Feb. 16, 2012

(54) CONFIGURING A POLICY FOR SHARING BROWSER HISTORY

(75) Inventors: ERIK J. BURCKART, RALEIGH, NC (US); ANDREW IVORY, WAKE FOREST, NC (US); TODD E. KAPLINGER, RALEIGH, NC (US); AARON K. SHOOK, RALEIGH, NC (US)

(73) Assignee: INTERNATIONAL BUSINESS MACHINES CORPORATION, ARMONK, NY (US)

(21) Appl. No.: 12/854,292

(22) Filed: Aug. 11, 2010

(51) Int. Cl. G06F 3/01; G06F 15/16

(52) U.S. Cl. 715/753

(57) ABSTRACT

A browser history is shared with peers in a social network by configuring a policy. What websites and what members are to be shared are defined in the policy. A history of the usage of the links to the defined websites by the defined members is gathered. The browser histories are published to a social networking service. The links are displayed to the user with a representation identifying the usage by the members.

### BACKGROUND

The present invention relates in general to social networks, and more particularly, to predicting web browser requests by a member of a social network based on a history of usage of the social network by members of the network.

Social web browsers, such as, for example, the open source browser provided by Flock, Inc. of Menlo Park, Calif., have started to combine web browsing and social networking. With such a browser, it is possible for a user to share a link to the social network. However, most people don't share every link that they hit, as it can be a time consuming exercise, and social browsers don't have the ability to predicatively fetch or highlight what other members of the social network have previously identified.

### BRIEF SUMMARY

According to one embodiment of the present invention, a method for configuring a policy for sharing browser history with peers within a social network comprises defining websites and members of the social network to be included in the policy. Under instructions from a microprocessor, a history of the usage of links to the defined websites by the members is gathered. The history is published to a social networking service. The links are displayed with a representation identifying the usage by the members.

According to one embodiment of the present invention, a computer system for configuring a policy for sharing browser history with peers within a social network comprises a processor programmed to define websites and members of the social network to be included in the policy. A history is gathered of the usage of links to the defined websites by the members. The history of usage of the social website is published. The links with a representation identifying the usage by the members upon access of the set of websites by a member of the social website are displayed.

According to one embodiment of the present invention, a computer program product configures a policy for sharing browser history with peers within a social network. The computer program product comprises a computer readable storage medium having computer readable program code embodied therewith. The computer readable program code is configured to define websites and members of the social network to be included in the policy. Computer readable program code is configured to gather history of usage of links to the defined websites by the members. Computer readable program code is configured to publish the history to a social networking service. The computer readable program code is configured to display the links with a representation identifying the usage by the members.

### BRIEF DESCRIPTION OF THE SEVERAL VIEWS OF THE DRAWINGS

FIG. 1 is an illustration of a computer system that may implement an embodiment of the present invention;

FIG. 2 is a flowchart illustrating the publishing of a social network history;

FIG. 3 is a flowchart illustrating the fetching of a social network history;

FIG. 4 is an illustration of the order of preferred web page layout; and

FIG. 5 is an illustration of a promotional layout of a web page.

### DETAILED DESCRIPTION

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

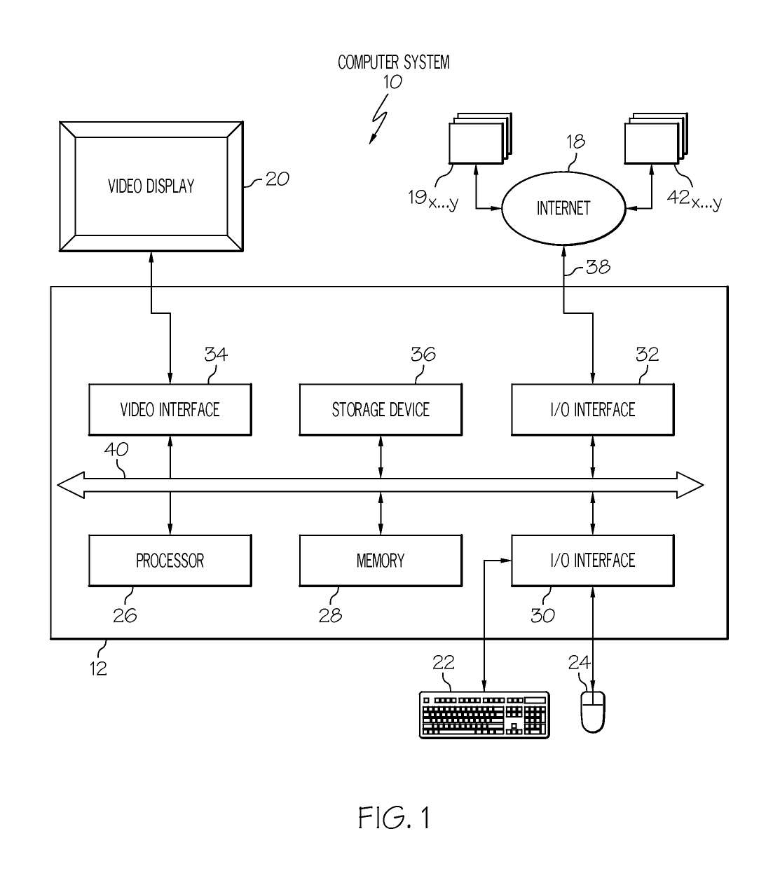

FIG. 1 is one example of a computer system 10 suitable for configuring a policy for sharing browser history with peers within a social network in accordance with the techniques described. Other processing devices which are suitable for executing the software can be a wireless telephone, personal assistant device (PDA), portable computer, smart remote control device, or any other processing devices that can execute such software.

The computer system 10 is of a type that executes under a suitable operating system installed on the computer system 10. The components of the computer system 10 include a computer 12, a keyboard 22, mouse 24, and a video display 20. The computer 12 includes a processor 26, a memory 28, input/output (I/O) interfaces 30 and 32, a video interface 34, and a storage device 36.

The processor 26 is a central processing unit (CPU) that executes the operating system and the computer software executing under the operating system. The memory 28 includes random access memory (RAM) and read-only memory (ROM), and is used under direction of the processor 26. The video interface 34 is connected to a video display 20 and provides video signals for display thereon. User input to operate the computer 12 is provided from the keyboard 22 and mouse 24. The storage device 36 can include a disk drive or any other suitable storage medium, as discussed above. Each of the components of the computer 12 is connected to an internal bus 40 that includes data, address, and control buses, to allow components of the computer 12 to communicate with each other via the bus 40. The computer system 10 can be connected to one or more other similar computer systems 42_{x . . . y} via an input/output (I/O) interface 32 using a communication channel 38 to a network, represented as the Internet 18. One or more servers 19_{x . . . y} may be connected to the computer system 10 via a network, such as, the Internet 18. The servers 19_{x . . . y} may comprise the same physical arrangement as the computer 12 and may be co-located with or a part of the computer 12.

The computer software may be recorded on a computer readable storage medium, in which case, the computer software program is accessed by the computer system 10 from the storage device 36. Alternatively, the computer software can be accessed directly from the Internet 18 by the computer 12. In either case, a user can interact with the computer system 10 using the keyboard 22 and mouse 24 to operate the programmed computer software executing on the computer 12.

In an embodiment of the present invention, a policy is configured for the sharing of a browser history. Additionally, a social network based browser history may allow prediction of which links a user will click on in a given site. For example, when NA people are within User A's social network, and MA are those people within NA who have visited, within a certain timeframe, the site User A is accessing, evaluate each link within the site.

If Y>P×MA,
where Y equals the number of people within NA who visited that link within the site, and P equals a minimum popularity index (e.g. 25%), then the social browser or the website may pre-cache and/or highlight the URL.
   The popularity index is a predefined factor that is determined through the use of a microprocessor, either by the web site or the user's browser, such as, for example, a number of accesses in a certain amount of time. Furthermore, if EA represents those users that have expressed similar “likes” to User A and are sharing their browsing history for the given site, and FA are those users within EA that have accessed this same site within a certain timeframe, then:

if FA/EA>P,

the browser or website may pre-cache in a memory and/or highlight the URL. Such pre-caching or highlighting allows a prediction of what the user will want to view.

The website may do the pre-cache and/or highlight of the URL through javascript which allows the material to start loading in the HEAD section of a page, in order to have the necessary material in the browser's cache before the script starts to run. The website can accomplish this with information gathered through the browser's social media interfaces which are typically in javascript. Alternatively, the social browser may pre-cache and/or highlight the URL through its programmatic APIs and the rendering of the page will not require the use of javascript.

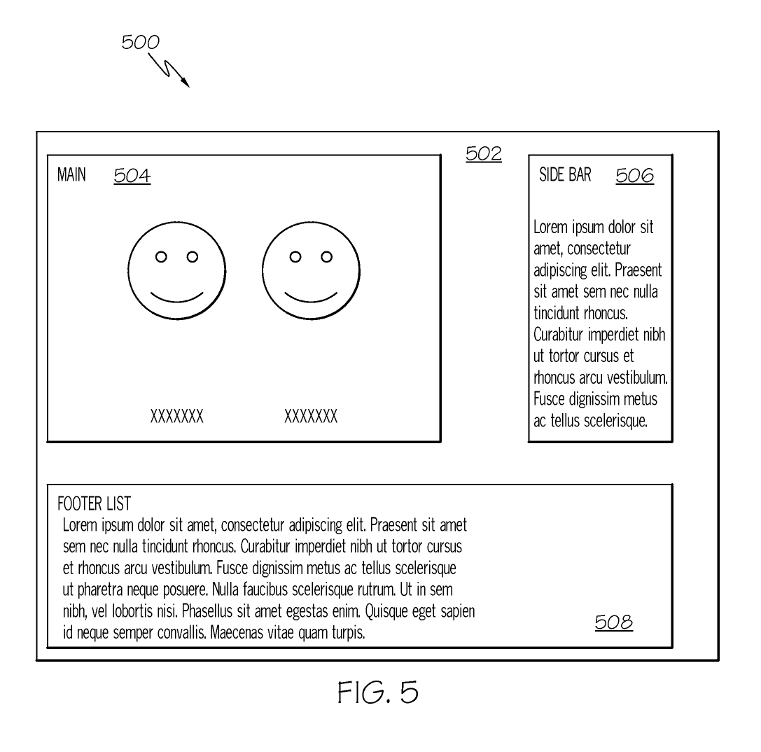

Once the URL's to be pre-cached or highlighted are determined, the social browser or the website may optionally promote (meaning to indicate an increased value to the user by its positioning on a page) those links via javascript. A website may further utilize pre-cached or highlighted information to promote relevant content to a user by declaring multiple sections on a page. Referring to FIG. 5, an example of a news website 500 is shown. On site 500 a page 502 is arranged with sections, for example, a “Main” section 504, a “Side bar” section 506, and a “Footer list” section 508. The “Main” section 504 may display the most content, showing images, flash graphics, or just a few links to the most important (relevant to the specific user) stories of the day. The “Side Bar” section 506 may have the second most important stories but, perhaps, no more than a dozen. At the “Footer List” section 508 there may be a much longer list of the overall stories and content. Each of the news items shown on page 502 has an entry in a data store, such as a database, which includes an image, the full text, and multiple catchy summaries that may be displayed. If an item is to be promoted from the “Footer List” section 508 to the “Main” section 504, the website would pull information from the data store about that item and replace the image in the “Main” section 504, as well as the links to the store for that specific news page. Information in the data store may also be what the website decides to programmatically pre-fetch, if it is predicted the story will be clicked on by the user. If that data is pre-fetched, it may be possible to display all the text for the news story without the need to load a new browser page.

The social browser can allow some or all sharing of access history of a site, a particular page within a site, or all sites with some portion of their social network. This could be all users, all friends, or select friends. For example, the user may configure the social browser only to share pages on which they click the “Like” button. The browser may also allow, for example, the history sharing of all pages on specific websites only.

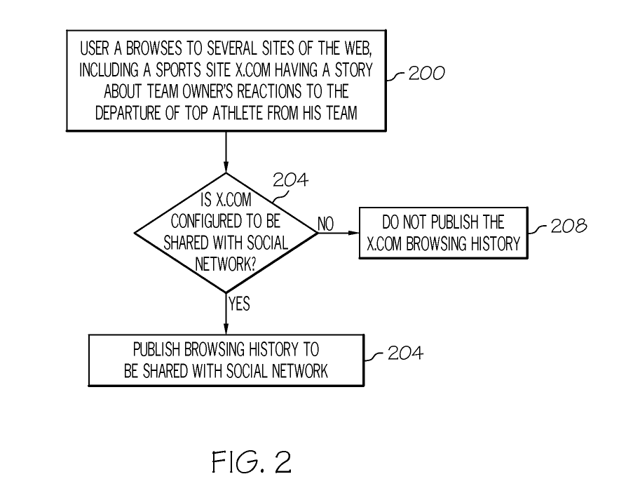

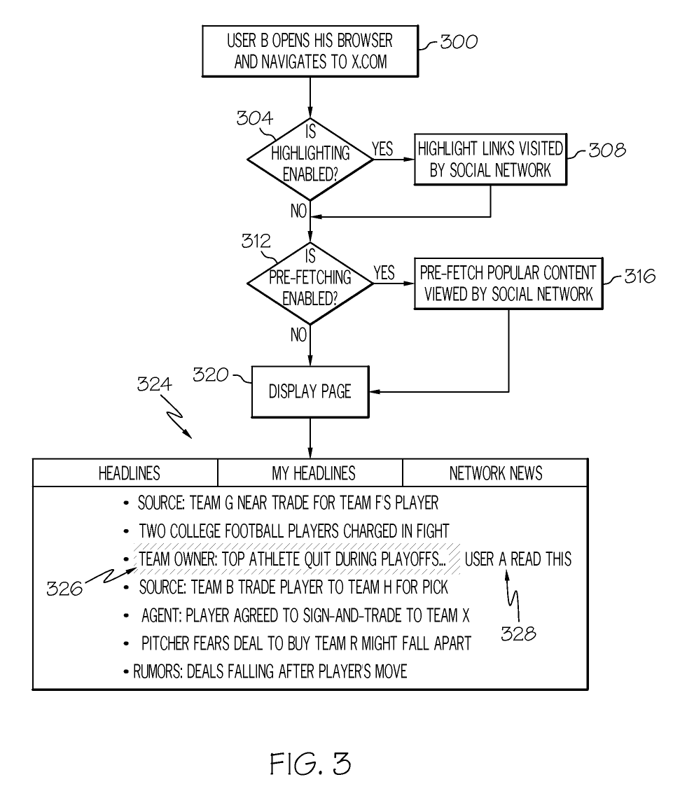

In conjunction with FIGS. 2 and 3, the following example will be described. A user of a social browser is interested in sports related news and events. The user is also a member of a social network with a primary interest in sports. As a result of the user's membership in the social network, it is inferred that the user has interests in common with the other members and, therefore, will be interested in what the other members have accessed. The social browser has a configurable set of sites, as described above, that it will allow sharing of the history of access by the social network members. Periodically, the history for those sites will be batch pushed to a server which will store and index the history.

Referring now to FIG. 2, a flowchart illustrates the publishing of a social network history to a social networking service. A social networking service may be, for example, a website, a web-service, or a peer-to-peer technology. At block 200, a User A (User A is a member of the sports social network) browses, using a social browser, to several sites on the web including one from the configurable set of sites (x.com). Sports site x.com has a story about Team Owner's reactions to the departure of Top Athlete from his Team. At decision block 204, it is determined whether a history of usage of x.com is configured to be shared with a social network. If it is determined to not be configured for sharing with a social network, the process does not publish the browsing history at block 208. If the response to decision block 204 is yes, the browsing history to be shared is published at block 212

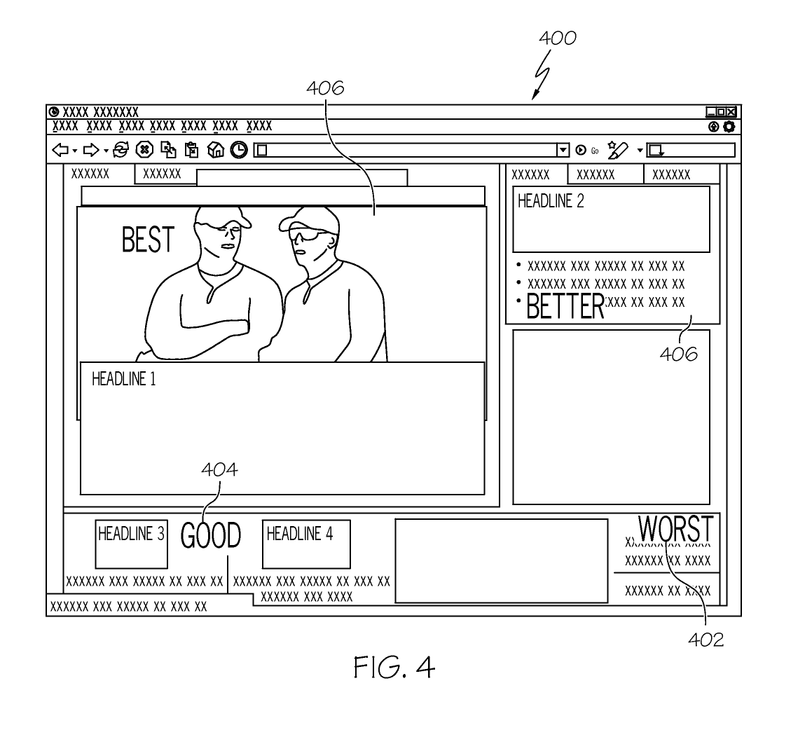

When a user first enters one of the allowed sites, their social browser pulls down the social network's histories. If there are particular links that the user is likely to hit, the browser can highlight or pre-fetch those links. The browser could also offer a basic means to promote a link to a more prestigious location on the page. A more prestigious location arrangement can be seen on an example page 400 shown in FIG. 4. The locations are labeled on the page from WORST 402 to GOOD 404 to BETTER 406 and to BEST 408. For example, a specific news article typically will at least have a title, a short headline, an excerpt, an image and an abstract. An embodiment of the present invention promotes a link that may include any metadata about the link such as title, headline, and image for its new more prominent position on the page. If the website gets this information using JavaScript, it may choose to promote the articles that are most relevant to the audience to the best location of the page.

Continuing with the example above and with reference to FIG. 3, User B opens his social browser and navigates to the sports site x.com at block 300. At decision block 304, it is determined whether a highlighting function is enabled. If the response to decision block 304 is yes, the links visited by members of the social network are highlighted at block 308. After block 308, or if the response to decision block 304 is no, the process continues to decision block 312.

At decision block 312, it is determined whether pre-fetching (identifies and displays links to sites predicted by the social browser to be of heightened interest to User B) is enabled. Pre-fetching allows the browser to select the content for the user and to begin downloading it before the user actually selects it. Then, when the user selects the content the browser has already downloaded or begun to download the content, allowing for a much faster presentation of the content. This may serve to improve the user's experience with the website. If the response to decision block 312 is yes, the content of heightened interest is obtained at block 316 and stored by the browser in a local memory.

After block 316 or if the response to decision block 312 is no, a page is displayed at block 320. As identified by reference numeral 324, an example page displayed by the social browser is shown. The summarized information is displayed and any item can be selected to go to the site where the specific information is located. If a specific page in the list may be of heightened interest to the user, it may be highlighted, for example, as indicated by reference numeral 326. If pre-fetching has been enabled, User B may select the item of interest, and it will be displayed from the local memory. In addition, as indicated by reference numeral 328, specific information may also be displayed with reference to the other social network member (User A) who viewed the material.

Thus, social browsers may allow users to share their browsing histories for specific sites (e.g. a sport news site) or all sites. This will allow the best links to be presented, highlighted, or pre-fetched based on the material that has been of the most interest to other members of the user's social network.

The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for configuring a policy for sharing browser history with peers within a social network, comprising:
defining websites and members of the social network to be included in the policy;
gathering, under instructions from a microprocessor, history of usage of links to said defined websites by said members;
publishing said history to a social networking service; and
displaying said links with a representation identifying said usage by said members.

2. The method of claim 1, wherein said social networking service comprises a social website.

3. The method of claim 1, wherein said social networking service comprises a social browser.

4. The method of claim 1, wherein said representation identifying said usage further comprises highlighting links that are of heightened interest to a user.

5. The method of claim 1, wherein said representation identifying said usage further comprises adding comments from said members.

6. The method of claim 1, wherein said representation identifying said usage further comprises calculating a popularity index for each of said links in order to rank said links.

7. The method of claim 1, wherein said representation identifying said usage by said members further comprises predicting, using said microprocessor, based upon a calculated probability, which of said links a user will select and pre-fetching material from said links.

8. The method of claim 7, further comprising promoting said links within a displayed page based upon said calculated probability.

9. A computer system for configuring a policy for sharing browser history with peers within a social network, comprising a processor programmed to:
define websites and members of the social network to be included in the policy;
gather history of usage of links to said defined websites by said members;
publish said history to a social networking service; and
display said links with a representation identifying said usage by said members.

10. The computer system of claim 9, wherein said social networking service comprises a social website.

11. The computer system of claim 9, wherein said social networking service comprises a social browser.

12. The computer system of claim 9, wherein the processor is further programmed to highlight links that are of heightened interest to a user.

13. The computer system of claim 9, wherein said representation identifying said usage further comprises added comments from said members.

14. The computer system of claim 9, wherein said representation identifying said usage further comprises a calculated a popularity index for each of said links in order to rank said links.

15. The computer system of claim 9, wherein said representation identifying said usage by said members further comprises a prediction, based upon a calculated probability, of which of said links a user will select in order to pre-fetch material from said links.

16. The computer system of claim 15, wherein the processor is further programmed to promote said links within a displayed page based upon said calculated probability.

17. A computer program product for configuring a policy for sharing browser history with peers within a social network, the computer program product comprising a computer readable storage medium having computer readable program code embodied therewith, the computer readable program code comprising:
computer readable program code configured to define websites and members of the social network to be included in the policy;
computer readable program code configured to gather history of usage of links to said defined websites by said members;
computer readable program code configured to publish said history to a social networking service; and
computer readable program code configured to display said links with a representation identifying said usage by said members.

18. The computer program product of claim 17, wherein said social networking service comprises a social website.

19. The computer program product of claim 17, further comprising computer readable program code configured to calculate a popularity index for each of said links in order to rank said links.

20. The computer program product of claim 17, further comprising computer readable program code configured to predict, based upon a calculated probability, which of said links a user will select and pre-fetching material from said links.
